(19) United States
(12) Patent Application Publication
(10) Pub. No.: US 2013/0179180 A1
(43) Pub. Date: Jul. 11, 2013

(54) Rx Hub

(71) Applicant: Gyanendra Patra, Katy, TX (US)

(72) Inventor: Gyanendra Patra, Katy, TX (US)

(21) Appl. No.: 13/346,450

(22) Filed: Jan. 9, 2012

(51) Int. Cl. G06Q 50/22

(52) U.S. Cl. 705/2

(57) ABSTRACT

A system and method for use with e-prescription allows the consumers to receive electronic prescriptions from prescribers and store it in a secure online storage and provide permission to the pharmacy to view it for fulfillment. The consumers are given opportunities to inquire prices for the medication by searching internet or by calling pharmacies before asking a pharmacy to fulfill their prescriptions.

### BACKGROUND OF THE INVENTION

1. Field of the Invention

The present invention relates to a system and method for use with e-prescription, and more particularly to a system that will allow the consumers to receive electronic prescriptions from prescribers and store it in a secure online storage and provide permission to the pharmacy to view it for fulfillment.

2. Description of Related Art

It is known that prescription drug price has wide variance among retail pharmacies even within the same geographic location. The price can vary 20% to 100% in every geographic location. According to one report, searches on a state managed price finder show that prices for the same drugs can vary from pharmacy to pharmacy by as much as 500 percent. Adding to this complexity, mail order pharmacies are normally 30% cheaper than the retail pharmacies and mail order pharmacy is growing at a fast rate which leads to increasing price variation of prescription drug nationwide.

Most of the consumers are concerned about the cost of their prescription medications. The out-of-pocket expense for prescription drugs is increased due to increasing insurance cost, increasing co-payment, increasing deductibles, etc. As such, consumers are forced to better control the cost of prescription drug and are forced to shop around for the best price. Nevertheless, shopping for the best price can be difficult and time consuming. It is known that the retail/mail order pharmacies may have daily price change for the same drug, but daily drug pricing information is not easily accessible. Except a few pharmacies (e.g. Costco, and Drugstore.com), most pharmacies do not advertise or even display prescription drug prices. The price lists of prescription drugs managed on state government website are limited to most commonly used prescription drugs and does not reflect the daily price change.

Moreover, there are several problems with the existing e-prescription drug delivery system where Surescripts directly connects prescribers to pharmacy.

In the existing e-prescriptions drug delivery system, there is no means for the consumer to compare and look for the lowest price of the drug before choosing the pharmacy so it is more or less a random choice of the consumer when they choose the pharmacy for the prescriber to select (input) in the e-prescription. Because the prescriber is responsible for inputting the pharmacy in the e-prescription software, once selected, this can not be changed without the consumer asking the physician to cancel the existing one and recreate a new one by choosing a different pharmacy of consumer's choice. Up to now, there is no system or method in the prior art that addresses these problems.

Accordingly, there is a need for a system and method that will allow the consumers to receive electronic prescriptions from prescribers and store it in a secure online storage before they decide which pharmacy they want their prescriptions to be filled.

### SUMMARY OF THE INVENTION

An object of the present invention is to let consumer in control to choose the pharmacy.

Another object of the present invention is to provide a secure online storage for e-prescription so that consumers can have control over which pharmacy they want their prescriptions to be filled based on sound decision making process.

Another object of the present invention is to provide consumers an identification code which they can give to the pharmacy in order to view the e-prescription for fulfillment.

A system and method according to the present invention provides a website or app in mobile device for consumer to log in. Once the consumer registers on the website the system and method creates a consumer account and provides access credentials (userid/password) for consumer to log in. The system and method also provides consumer an identification (ID) code for providing to the pharmacy to look up in the client system within the present invention's e-prescription exchange system. The present invention's “e-prescription exchange system” has connection with an external e-prescription software vendor's server through “RX exchange portal” within the software or on the e-prescription software vendor's website. The “RX exchange portal” allows the prescriber to send e-prescription to the present invention's RX exchange system when using the e-prescription software provided by an external e-prescription software vendor.

When a consumer visits a prescriber who can be any medical professionals that are qualified to write a prescription, the consumer can ask the prescriber to send the e-prescription to the “RX Exchange portal” instead of any pharmacy. By selecting the “RX Exchange portal” using consumer's ID code, the “e-prescription Packet” populated with all the details by e-prescription software will be sent to and stored in a secure online storage which is the database of web server. The system will then allocate the e-prescription to the respective consumer account and notify the consumer or consumer's representative to log in the account and view the new e-prescription. Consumer can log into his account using his credentials (user id/password) and views the prescription. The e-prescription will also be allocated in the client system where the pharmacy representative can log in and view the consumer's e-prescription according to the consumer's ID code.

Consumer can immediately visit the pharmacy and provides ID code to pharmacy to fulfill the prescription. Alternatively, consumer can shop and find out which pharmacy provides the lowest price for the prescribed medicine by searching on internet and/or by calling pharmacies and/or by other means. After the consumer decides which pharmacy is his best choice, the consumer can visit the pharmacy and provides his ID to pharmacy.

Pharmacy representative logs into the present invention's RX exchange system and lookups in the client system based on the consumer's ID. Pharmacy representative views the pending prescriptions and Select the prescription that need to be filled, select the no of refills if there is any. If the prescription is valid, then pharmacy representative acquires the e-prescription by clicking a button. the present invention's central system sends the prescription to pharmacy processing system either directly or thru the external system from where the prescription was originated. Central System update the prescription in consumer system as acquired by pharmacy with details and Update the consumer system with remaining refills.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a flow chart showing an exemplary existing system and method showing that consumer has no control over prescription drug price.

FIG. 2 is a flow chart showing one embodiment of the present invention that that allows the consumers to receive electronic prescriptions from prescribers and store it in a secure online storage and provide permission to the pharmacy to view it for fulfillment.

FIG. 3 is a flow chart showing a second embodiment of the present invention that that allows the consumers to receive electronic prescriptions from prescribers and store it in a secure online storage and provide permission to the pharmacy to view it for fulfillment.

### DESCRIPTION OF THE PREFERRED EMBODIMENT

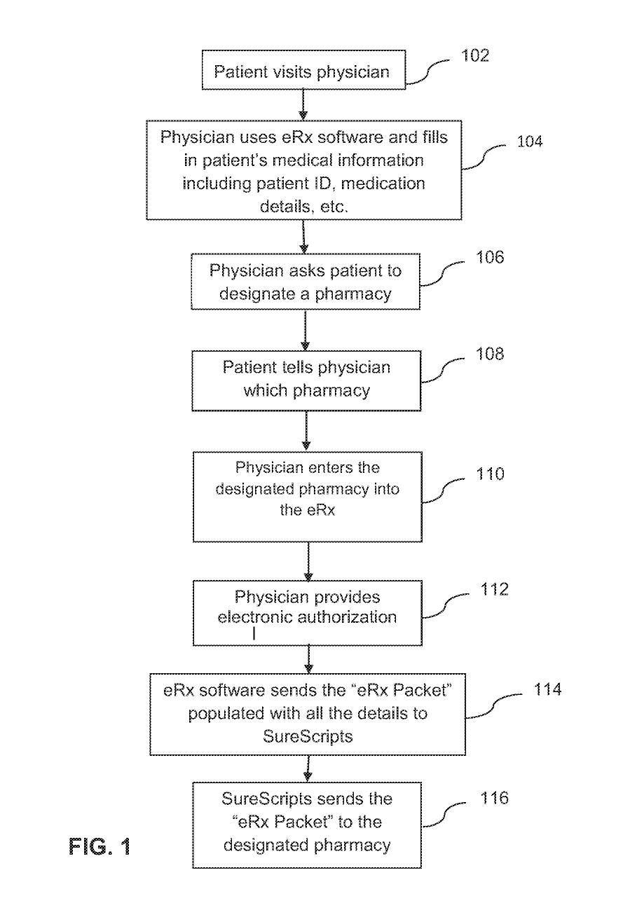

In order to grasp the advantage of the new system and method of the present invention over the existing system, before explaining the new system and method of the present invention, referring to FIG. 1 there is disclosed the work flow of the existing system and method. First, a consumer visits a prescriber (step 102). After examining the consumer, the prescriber decides to write a prescription using e-prescription software provided by the e-prescription software vendor. The prescriber enters prescriber's ID (pre-populated by the e-prescription software), consumer's ID (physician selects the consumer's ID if it is already there or adds the new consumer in the e-prescription software), and the medication details (step 104). Then, the prescriber asks consumer for the pharmacy and the consumer tells the prescriber his/her preferred pharmacy (step 106 and 108). The prescriber enters the pharmacy into the e-prescription, provides electronic authorization and sends the e-prescription to the e-prescription system provider (step 110 and 112). The eprescription software in turn sends the “e-prescription Packet” populated with all the details to Surescripts (step 114). In turn Surescripts sends this to the designated pharmacy to get it filled (step 116).

The existing system does not provide the consumer control over the prescription drug price or pharmacies because the pharmacy is a random choice of the consumer or doctor. Once selected, the pharmacy cannot be changed without the consumer asking the physician to cancel the existing one and recreate a new one by choosing a different pharmacy of consumer's choice. Even if the selected pharmacy is a well made decision at the time when consumer visited prescriber. Because the prescription drug price may change daily the selected pharmacy may not have the best deal all the time. The existing system and method does not provide tool to overcome a dynamic price changing market; the consumer is not given options to shop around for the best deal using the existing system.

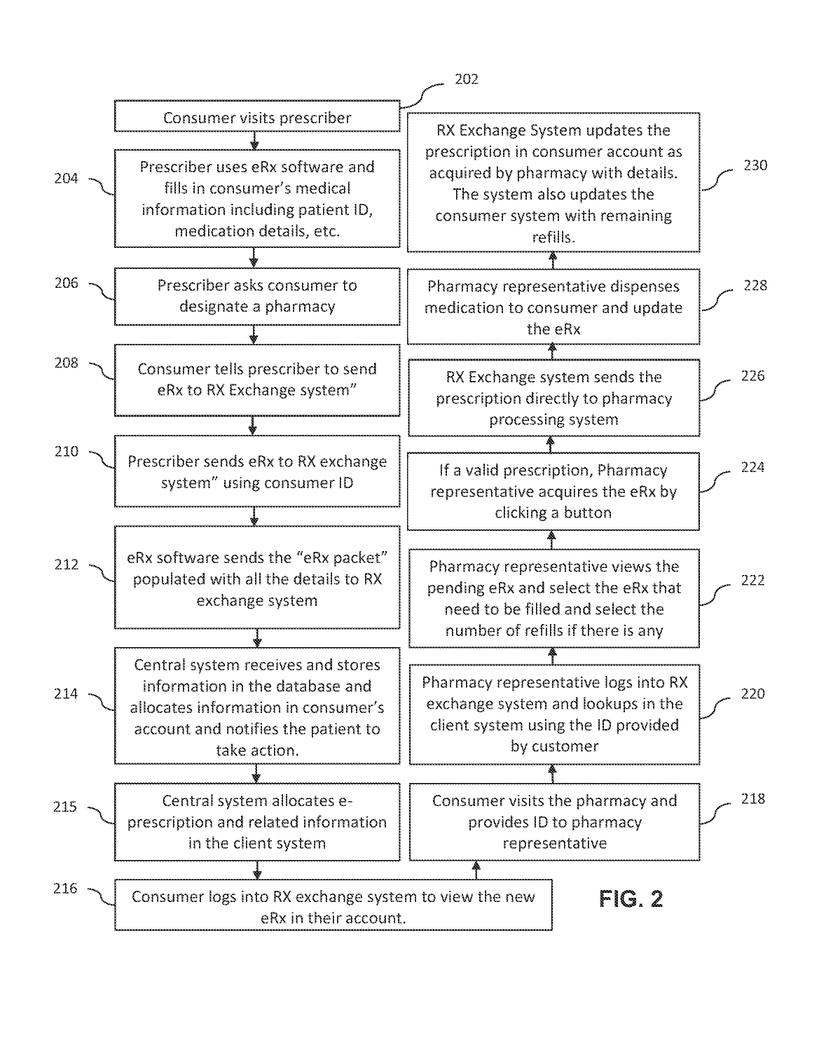

Referring to FIG. 2, there is disclosed a first embodiment of a new system and method according to the present invention. Steps 202 through 206 in FIG. 2 are the same as steps 102 through 106 in FIG. 1. Instead of randomly selecting a pharmacy, consumer asks physician to send the e-prescription to the “RX Exchange Portal” in the e-prescription software which is the central system (step 208) of the present invention (the present invention). Upon the consumer's request, the prescriber selects the “RX Exchange Portal”, provides electronic authorization and sends out the e-prescription (step 210). Then, e-prescription software sending the “e-prescription Packet” populated with all the details to the central system (step 212) of the present invention. After receiving the consumer's e-prescription packet, the present invention's central system stores e-prescription packet on the server and allocates information in consumer's account and notifies the patient to take action (step 214). The e-prescription will also be allocated in the client system (step 215) where the pharmacy representative can log in and view the consumer's e-prescription according to the consumer's ID code. The consumer or consumer's representative logs into the present invention's central system either through website or the mobile device app that is provided by the present invention to view the new e-prescription (step 216). This step is optional and can be skipped if desired. The order of steps may be altered in other embodiments.

Consumer can choose to immediately visit the pharmacy and provides identification (ID) to pharmacy representative to fill the prescription (step 218). Alternatively, consumer can choose to shop and find out which pharmacy provides the lowest price for the prescribed medicine by searching on internet and/or by calling pharmacies and/or by other means. After the consumer decides which pharmacy is their best choice, the consumer can visit the pharmacy and provides his ID to pharmacy representative (step 218).

The pharmacy representative logs into the present invention's RX exchange system and look ups in the client system based on the consumer's ID code (step 220). Pharmacy representative views the pending prescriptions and select the prescription that need to be filled, Select the no of refills if there is any (step 222). If the prescription is valid, the pharmacy representative acquires the e-prescription by clicking a button (step 224). The present invention's central system directly sends the prescription to pharmacy processing system either (step 226). After pharmacy representative dispenses medication to consumer and updates the e-prescription (step 228), the present invention's RX exchange system updates the prescription in consumer account as acquired by pharmacy with details and updates the consumer's account with remaining refills (step 230).

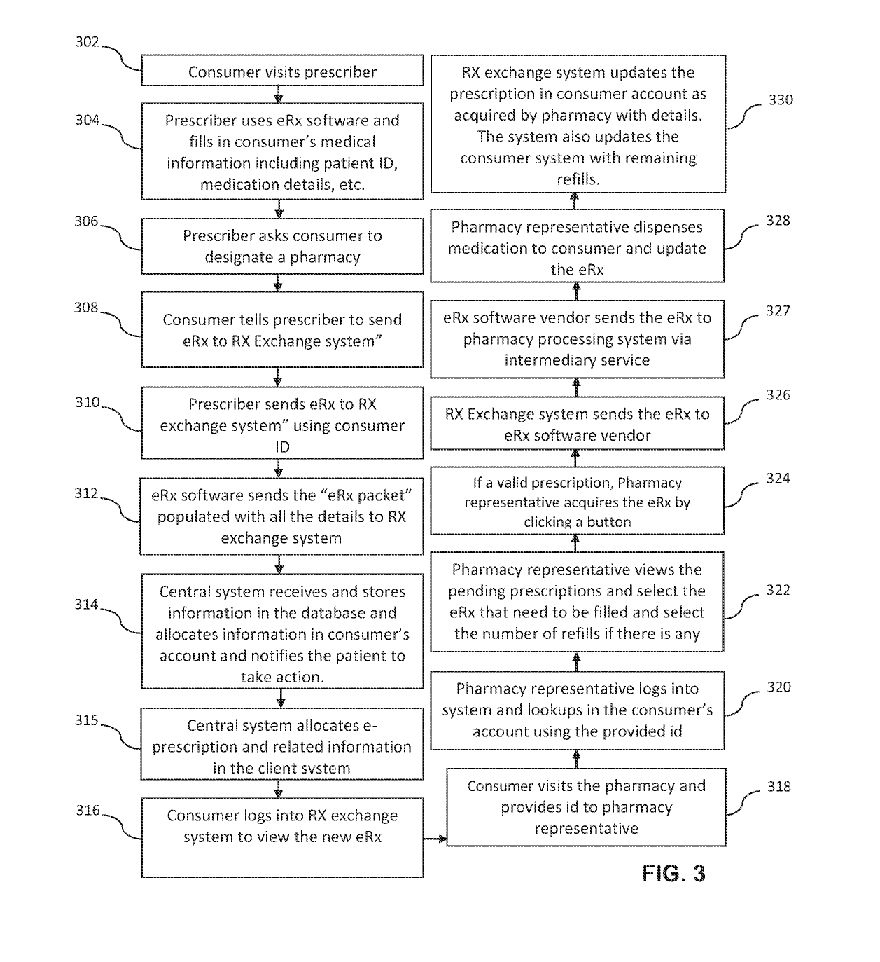

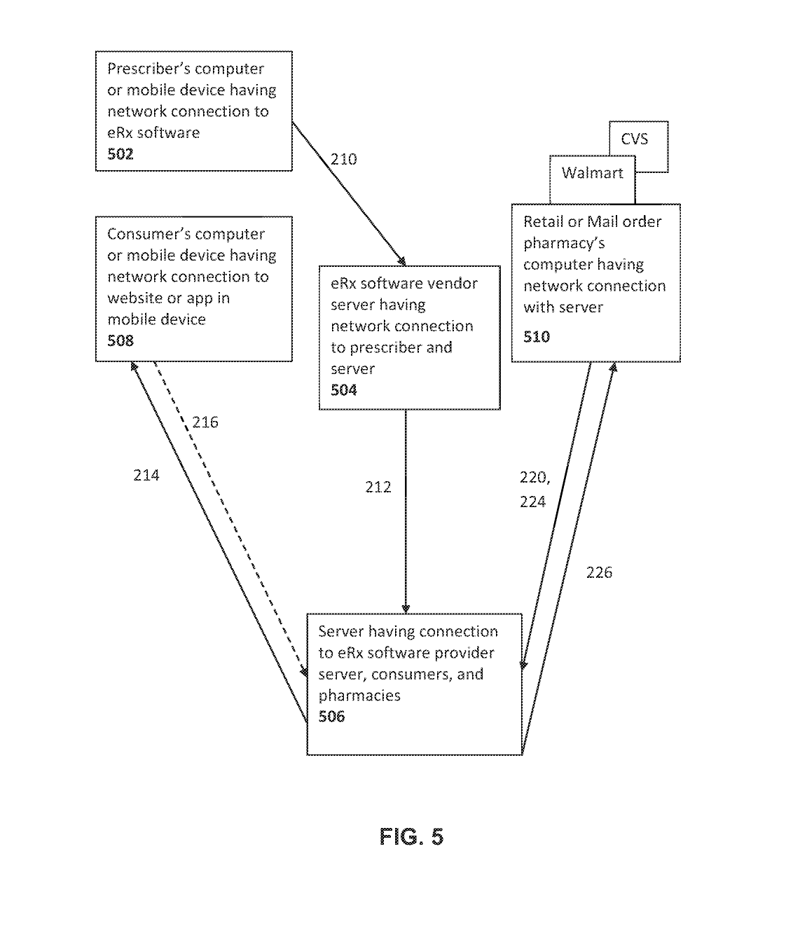

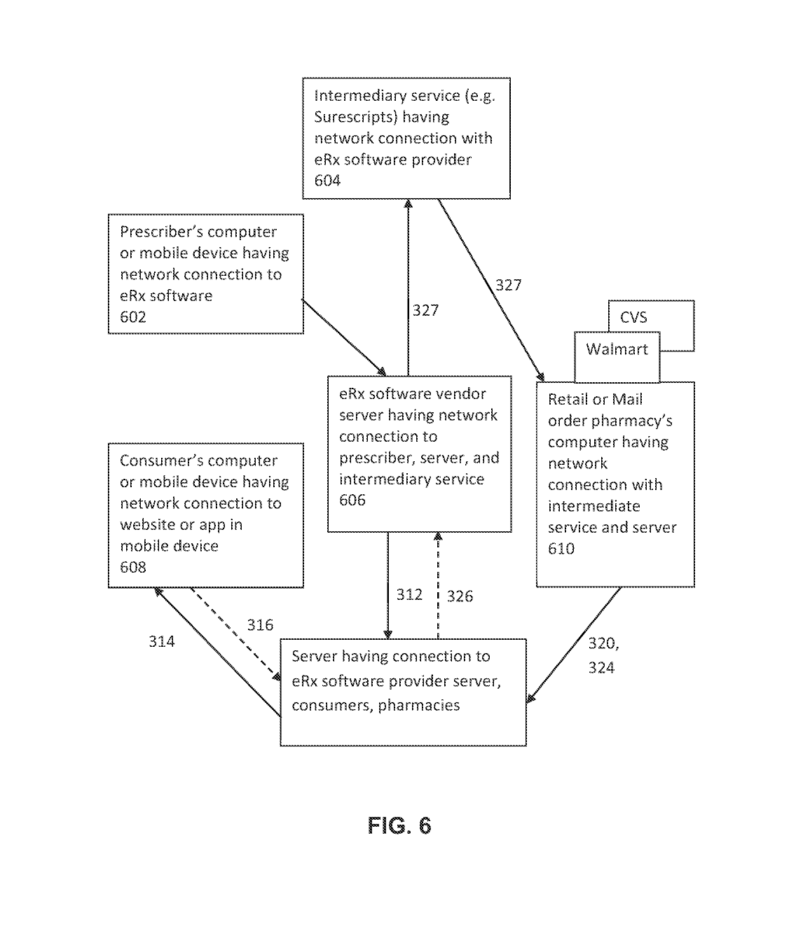

In an alternative embodiment disclosed in FIG. 3, the present invention's central system sends the prescription to pharmacy processing system thru the external system from where the prescription was originated, for example, the e-prescription software vendor (step 326). The e-prescription software vendor may then transmit the e-prescription to the pharmacy process system through an intermediary service (e.g. Surescripts) (step 327). After pharmacy representative dispenses medication to consumer and updates the e-prescription (step 328), the present invention's RX exchange system updates the prescription in consumer account as acquired by pharmacy with details and updates the consumer's account with remaining refills (step 330).

According to these embodiments of the present system and method, consumers are given opportunities to inquire prices for the medication by searching internet or by calling pharmacies before picking up a pharmacy to fulfill their prescription.

The system and method of the present invention includes computers and/or mobile device with internet access in the prescriber's office and pharmacies. The computer or mobile device should be installed with e-prescription software or have access to the e-prescription software provider's website. Consumer can use computer or mobile device to register and log in the account on the website of the present invention. The networking implemented to connect the prescriber, electronic software provider, website's server (central system) of the present invention, consumer, intermediary service (e.g. Surescripts), and pharmacies involved in the present invention for the embodiment presented in FIG. 2 and FIG. 3 are illustrated in FIG. 4 and FIG. 5, respectively. The networking arrangements are known to those with ordinary skill in the arts.

The network communication implemented in the first embodiment disclosed in FIG. 2 is illustrated in FIG. 4, where the prescriber's computer or mobile device 402 having network connection to e-prescription software; the e-prescription software vendor server 404 having network connection to prescriber and the present invention's server; the present invention's server 406 having connection to e-prescription software provider server, consumer, and participating or non-participating pharmacies; the consumer's computer or mobile device 408 having network connection to the present invention's website or app in mobile device; and the retail or mail order pharmacy's computer 410 having network connection with the present invention.

Referring to FIG. 5, there is disclosed a diagram showing the network connecting the parties involved in the second embodiment disclosed in FIG. 3 where the prescriber's computer or mobile device 502 having network connection to e-prescription software; the e-prescription software vendor server 504 having network connection to prescriber, intermediary service, and the present invention's server; the present invention's server 506 having connection to e-prescription software provider server, consumer, and participating or non-participating pharmacies; the consumer's computer or mobile device 508 having network connection to the present invention's website or app in mobile device; and the retail or Mail order pharmacy's computer 510 having network connection with the present invention and intermediary service.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A method comprising:
a. providing a website for customers to register and log in;
b. creating a consumer account on the website upon a consumer's registration and providing the consumer access credential for logging in the account;
c. providing a client system for pharmacy representative to log in;
d. creating a consumer identification code for the client system;
e. providing a RX exchange portal option within an e-prescription software for prescribers to select when using the e-prescription software provided by an e-prescription vendor;
f. receiving “e-prescription packet” populated with all the details by the e-prescription software from the e-prescription software provider through a network;
g. storing the “e-prescription packet” on the web server;
h. allocating the e-prescription to the respective consumer account and notifying the consumer or consumer's representative to log in the account and view the new e-prescription;
i. allocating the “e-prescription packet” to the client system where pharmacy representative logs in and view the e-prescription using consumer's identification code and acquires a valid prescription by clicking a button; and
j. sending the e-prescription to a pharmacy processing system.

2. The method of claim 1 further comprising: providing app in mobile device for consumer to log in.

3. The method of claim 1, wherein the e-prescription is sent to the pharmacy processing system through the external system from where the prescription was originated.

4. The method of claim 1, wherein the e-prescription is directly sent to the pharmacy processing system.

5. The method of claim 1 wherein after the e-prescription is sent to the pharmacy processing system, pharmacy representative dispensing medication to consumer and updating the e-prescription.

6. The method of claim 5 further comprising updating the prescription in consumer account as acquired by pharmacy with details after the e-prescription is sent to pharmacy processing system and pharmacy representative dispenses medication to consumer and updates the e-prescription.

7. The method of claim 6 further comprising updating the consumer account with remaining refills.

8. The method of claim 1 further comprising establishing network communication between the website's server and the e-prescription software vendor in order to transmit the e-prescription to the website's server through a patient portal on e-prescription software.

9. The method of claim 1 wherein the e-prescription and consumer information provided in “e-prescription packet” is stored in the database of the website's server.

10. A system comprising:
a. a website for customers to register, get log in credential, and consumer identification, log in and view e-prescription, the website creating consumer account upon consumers' registration and providing consumers identification;
b. a network setup that receives e-prescription and patient information from e-prescription software providers;
c. a database on the website's server to store e-prescription and consumer information; and
d. a client system where pharmacy representative logs in and looks up for consumer's e-prescription using consumer's ID and acquires a valid e-prescription by clicking a button.

11. The system of claim 10 further comprising:
a network setup that sends e-prescription to a pharmacy processing system through the external system from where the prescription was originated.

12. A method comprising:
providing a “RX exchange portal” within e-prescription software for prescribers to send consumer's e-prescription to a secure online storage and providing an identification (ID) code to consumer so that consumer can provide the consumer ID code to any pharmacy of choice to view and fulfill the e-prescription.

13. The method of claim 12 further comprising providing a secure online storage to store the e-prescription packet transmitted from an e-prescription software vender.

14. The method of claim 12 further comprising providing a website for consumers to access.

15. The method of claim 14 further comprising creating consumer accounts for consumer to log in and view the e-prescription on the website.

16. The method of claim 12 further comprising providing a client system where pharmacy representative logs in and looks up for consumer's e-prescription using consumer's ID and acquires a valid e-prescription by clicking a button.

17. The method of claim 12 further comprising sending e-prescription to a pharmacy processing system.

18. The method of claim 12 further comprising sending e-prescription to a pharmacy processing system through the external system from where the prescription was originated.

19. The method of claim 12 further comprising updating the prescription in consumer account as acquired by pharmacy with details after the e-prescription is sent to a pharmacy processing system and pharmacy representative dispenses medication to consumer and updates the e-prescription.

20. The method of claim 19 further comprising updating the consumer account with remaining refills.
